(19) United States
(12) Patent Application Publication
(10) Pub. No.: US 2013/0313177 A1
(43) Pub. Date: Nov. 28, 2013

(54) DEVICE FOR SEPARATING FERROMAGNETIC PARTICLES FROM A SUSPENSION

(71) Applicants: Vladimir Danov, Erlangen (DE); Werner Hartmann, Weisendorf (DE); Michael Römheld, Uttenreuth (DE); Andreas Schröter, Erlangen (DE)

(72) Inventors: Vladimir Danov, Erlangen (DE); Werner Hartmann, Weisendorf (DE); Michael Römheld, Uttenreuth (DE); Andreas Schröter, Erlangen (DE)

(21) Appl. No.: 13/984,630

(22) PCT Filed: Jan. 24, 2012
(86) PCT No.: PCT/EP12/51046

§ 371 Date: Aug. 9, 2013

(30) Foreign Application Priority Data
Feb. 9, 2011 (DE) 10 2011 003 825.6

(51) Int. Cl. B03C 1/14

(52) U.S. Cl. CPC B03C 1/14
USPC 210/220; 210/222

(57) ABSTRACT

A device separates ferromagnetic particles from a suspension. The device has a tubular reactor through which the suspension can flow and which has a first region and a second region in the passage direction. The device also has a device for generating a magnetic field along an inside reactor wall. In the second region the tubular reactor has a tailings discharge pipe and a concentrate separation channel surrounding said pipe. The cross-sectional area of the tubular reactor in the second region is larger than that in the first region.

### CROSS REFERENCE TO RELATED APPLICATIONS

This application is based on and hereby claims priority to International Application No. PCT/EP2012/051046 filed on Jan. 24, 2012 and German Application No. 10 2011 003 825.6 filed on Feb. 9, 2011, the contents of which are hereby incorporated by reference.

### BACKGROUND

The invention relates to a device for separating ferromagnetic particles from a suspension.

There are a great many technical tasks in which ferromagnetic particles need to be separated from a suspension. One important area in which this function occurs lies in the separation of ferromagnetic recoverable substance particles from a suspension containing ground ore. In this case it is not only a question of iron particles which are to be separated from an ore, but it is also possible to chemically couple other recoverable substances, such as particles containing copper for example, which are not in themselves ferromagnetic, with ferromagnetic particles, for example magnetite, and thereby selectively separate said recoverable substances from the suspension containing the total ore. Ore in this case is understood to be a stone raw material which contains recoverable substance particles, in particular metal compounds, which are reduced in a further reduction process to produce metals.

Magnetic separation methods are used in order to selectively extract ferromagnetic particles from the suspension and separate said particles. In this situation, a type of construction for magnetic separation systems has emerged as expedient which comprises a tubular reactor on which are arranged coils in such a manner that a magnetic field is generated on an inside reactor wall, at which magnetic field the ferromagnetic particles accumulate and said particles are transported away from there in a suitable manner.

Considered by itself, this magnetic separation method is already advantageous, but the quality of the separation (quality of concentrate) of magnetic particles is in this case still in need of optimization.

### SUMMARY

One possible object relates to in improving a magnetic separation system in such a manner that the quality of the separation of ferromagnetic particles is improved.

The inventors propose a device comprising a tubular reactor through which a suspension containing ferromagnetic particles can flow. Viewed in the direction of flow the reactor has a first region and a second region. Furthermore, the reactor has a device for generating a magnetic field, preferably magnetizing coils, which generate a magnetic field along an inside reactor wall—preferably a magnetic field which travels along the inside reactor wall. In the second region the tubular reactor has a tailings discharge pipe and a concentrate separation channel surrounding said pipe. In this situation the reactor is designed in such a manner that the cross-sectional area of the tubular reactor in the second region is larger than that in the first region.

The tubular reactor thus widens out in the second region compared with its cross-sectional area in the first region and at the same time splits into the tailings discharge pipe arranged centrally in the tubular reactor and into a concentrate separation channel surrounding said tailings discharge pipe. The ferromagnetic particles which adhere on the inside reactor wall held by magnetic forces and are moved along said inside reactor wall are diverted to the outside in the second region through the widening of the reactor, in which case the remainder of the suspension, which contains no or only a few ferromagnetic particles and which is also referred to as tailings, flows away into the tailings discharge pipe in the center of the reactor.

In this manner, due to gravity the greatest part of the tailings passes into the tailings discharge line and not into the concentrate separation channel, which is directed quasi to the outside in the second region. This has the result that the quality of concentrate, in other words the yield in terms of magnetic particles which are contained in the concentrate, is considerably greater than in the arrangements used previously in accordance with the related art.

Magnetic particles are in particular understood to be ferromagnetic particles and are subsequently also referred to as such. These also include in particular the compound particles mentioned in the introduction which include a chemical coupling between a ferromagnetic particle and a non-magnetic material.

As a general rule the tubular reactor has a circular cross-section. The circular cross-section is in particular expedient for providing an even magnetic field and in order to manufacture the reactor tube cost-effectively. In the case of a circular reactor, instead of the term cross-sectional area it is also possible to use the term reactor diameter which correlates directly therewith. If the cross-sectional form of the reactor should differ from the circular form, then the term diameter used later in the special description is to be regarded as equivalent to the term cross-sectional area of the reactor.

In an advantageous embodiment of the proposed device, the cross-sectional area of the tailings discharge pipe in the second region is at least equally as large as or larger than the diameter or the cross-sectional area of the reactor in the first region. This means that the concentrate in the concentrate separation channel is carried so far to the outside that the tailings can continue to flow unhindered in the second region and at least the same cross-section is available to the tailings for this purpose as in the first region of the reactor in total. The probability of the tailings attracted by gravity going astray into the concentrate separation channel is significantly lower as a result of this type of construction than is the case with the related art.

In a further preferred embodiment, viewed in the direction of flow a third region is provided in which the reactor widens out once again and in a further concentrate separation channel splits up a channel discharge pipe surrounded by said concentrate separation channel. In this case the same premise is again given that the diameter or the cross-sectional area of the reactor in the third region is greater than in the second. In this case the objective is again that the diameter of the tailings discharge pipe in the third region is at least equally as large as the diameter of the reactor in the second region. The effect of said third region, which in geometrical terms constitutes a second stage in the reactor, has the same effect as the widening of the reactor in the second region; the concentrate in the concentrate discharge channel is once again discharged to the outside and the tailings still remaining from the first stage can flow away in a wide discharge pipe due to gravity.

In special cases it can be advantageous to further increase the number of stages.

In a further advantageous embodiment a flushing device is provided, by which a flushing liquid can be flushed into the concentrate separation channel. Said flushing liquid effects a further flushing-out of the tailings which are still present in the concentrate or which have inadvertently found their way into the concentrate separation channel.

It is expedient in this case if the concentrate separation channel is narrowed with respect to the direction of flow after entry of the flushing liquid. This has the effect that an overpressure is produced above the narrowing, caused by the entry of the flushing liquid, and the tailings are moved with the flushing liquid against the direction of flow in the concentrate separation channel and directed back into the tailings discharge pipe.

Such a flushing device having the mode of action described can be arranged in the second and/or third region.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic cross-sectional view of a magnetic separation device according to the related art,

FIG. 2 shows a schematic cross-sectional view of a magnetic separation device having a reactor cross-section extended in the second region,

FIG. 3 shows a magnetic separation device according to FIG. 2 having an additional flushing device,

FIG. 4 shows a device for magnetic separation in accordance with FIG. 2 having a second expansion stage of the reactor cross-section,

FIG. 5 shows a magnetic separation device according to FIG. 4 having a flushing device in the third region and

FIG. 6 shows a magnetic separation device according to FIG. 5 having an additional flushing device in the second region.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

FIG. 2 shows a schematic cross-sectional view of a magnetic separation device 2 which comprises a tubular reactor 6. Arranged around the tubular reactor 6 units for generating a magnetic field which are designed in the form of coils 14. The coils 14 are arranged rotationally symmetrically around the reactor 6 and they cause a magnetic field, not illustrated here for the sake of clarity, to be generated in the interior, in particular present at an inside reactor wall 16. As a result of said magnetic field, ferromagnetic particles which are contained in a suspension 4 passing through the reactor are attracted to the inside reactor wall 16 and accumulate thereon. In particular as a result of suitable control of the different coils 14 the magnetic field can be configured in such a manner that it travels along a direction of flow 8 of the suspension 4 on the inside wall 16 of the reactor 6. Such a magnetic field is also referred to as a traveling field.

Where appropriate a likewise tubular, preferably cylindrical displacement body 5 can be arranged in the interior of the reactor 6, by which the suspension 4 is forced closer to the reactor wall 16 and thus more ferromagnetic particles are brought within range of the magnetic field.

The ferromagnetic particles present on the inside reactor wall 16 are directed along the wall 16 in the direction of flow 8 by the traveling field.

The device 2 is distinguished by the fact that the reactor 6 has a second region 12 in which the reactor 6 expands stepwise in its cross-sectional area. If it is assumed that the reactor 6 in question in an advantageous embodiment is a cylindrical reactor having a circular cross-section, a diameter 21 of the reactor 6 in a first region 10 is therefore smaller than a diameter 22 of the reactor 6 in the second region 12. Furthermore, the reactor 6 divides in the second region 12 into a tailings discharge pipe 18 and into a concentrate separation channel 20 surrounding said pipe 18. The concentrate separation channel 20 runs outwards at an angle in the transition from the first region 10 to the second region 12, in which case the tailings discharge pipe 18 preferably has at least the same diameter 24 as the diameter 21 of the reactor 6 in the first region.

In a vertically oriented reactor the movement of the suspension 4 substantially follows gravity, which is indicated by the arrow 38. In the transition between the first region 10 and the second region 12 with an approximately unchanged pipe cross-section there is no significant driving force for the tailings which could direct them into the concentrate separation channel 20.

Basically, the reactor 6 does not necessarily need to be set up vertically; it can also have horizontal direction components, in which case the suspension is where applicable forced under pressure into the reactor 6.

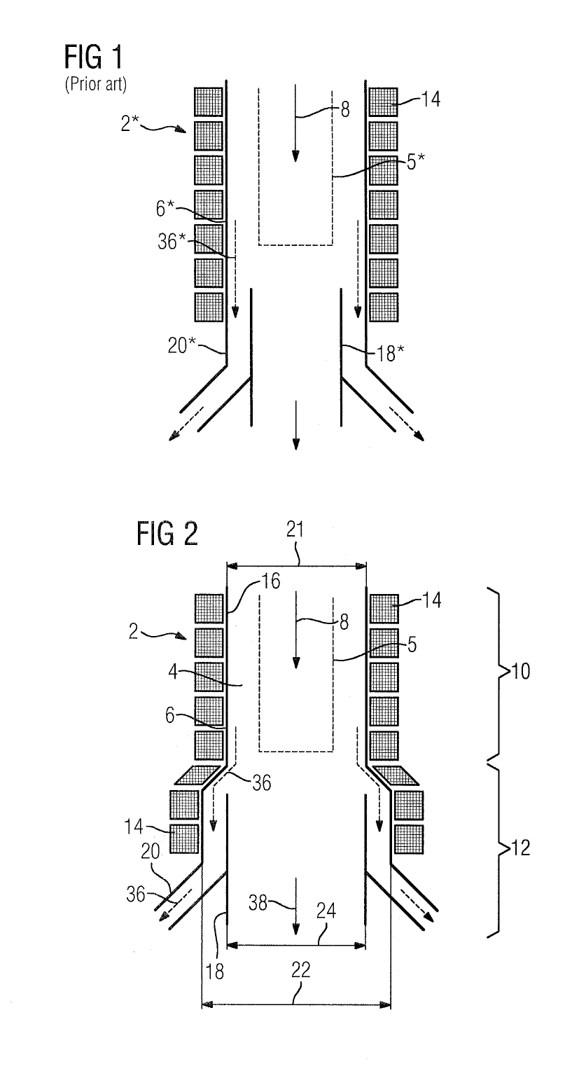

The ferromagnetic particles moved along the inside reactor wall 16 follow the arrow 36 in FIG. 2 into the concentrate separation channel 20. The quality of the separation, in other words the concentration of ferromagnetic particles which enters the concentrate separation channel 20, is greater than is the case with a device according to the related art, as illustrated for example in FIG. 1. The corresponding features in FIG. 1 are, because they carry the same designation as those in FIG. 2 but do not belong to the proposed device, provided with an asterisk. It can be seen from FIG. 1 that the tubular reactor 6* continues in the second region with the same diameter as in the first region, but the discharge pipe 18* for the tailings is narrower compared to the device according to FIG. 2. Because of this, it is possible in a disadvantageous form that a greater portion of the tailings is discharged through the concentrate separation channel 20*. Concentrate in accordance with FIG. 1 is thus not so highly concentrated as is the case with a device in accordance with FIG. 2. It may be necessary for a plurality of passes of the concentrate to take place in further separation devices 2* in order to achieve the same result as is the case with the device according to FIG. 2 in a single stage.

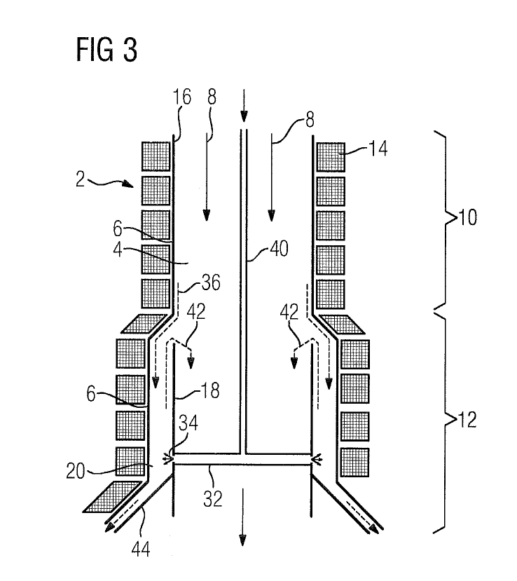

FIG. 3 illustrates a magnetic separation device 2 similar to that in FIG. 2, but which however has an additional flushing device 32. A flushing liquid 34 is directed into the concentrate separation channel 20 through a flushing liquid line 40 which by way of example is arranged here centrally in the tubular reactor 6. In this case it is expedient if the concentrate separation channel 20 narrows below the inlet for the flushing liquid 34. This is illustrated by the narrowing or constriction 44 in FIG. 3. The term “below” in this situation is understood such that the narrowing 44 is arranged below the flushing device in the direction of flow 8 which in practice, where the movement of the suspension 4 is determined by gravity, can also be referred to topographically as below. As a result of the narrowing 44 of the concentrate separation channel 20 an overpressure is produced in the channel 20 which results in tailings that have undesirably entered the channel 20 being forced along the arrow 42 back into the tailings discharge pipe 20.

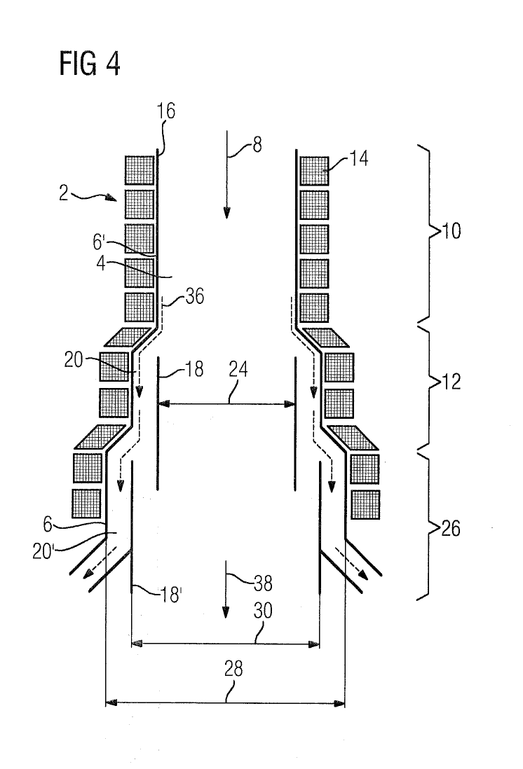

FIG. 4 now illustrates a device for magnetic separation having a two-stage tubular reactor 6. In contrast to the reactor 6 in FIG. 3, the reactor 6′ in FIG. 4 has a further enlargement of its cross-sectional area or its diameter in the form of a—viewed in the direction of flow 8—further stage. In this case it is also possible to speak of a two-stage reactor 6′. It can also be expedient to employ a reactor having more than two stages. The reactor 6′ has a third region 26 in which the reactor 6′ splits once again into a concentrate separation channel 20′ and a tailings discharge pipe 18′. The cross-sectional area or in the case of a circular cross-section the diameter 28 of the third region 26 of the reactor 6′ is accordingly greater than the diameter 24 of the second region 12. Likewise, in an expedient manner the tailings discharge pipe 18′ is designed such that it has the same cross-section or diameter 30 as or a greater cross-section or diameter 30 than the diameter 24 or the cross-section of the reactor 6′ in the second region 12.

The further widening of the reactor 6′ in the third region 26 has the same effect as has already been described in relation to the second region 12. The excess tailings can escape unimpeded through the tailings discharge pipe 18 due to gravity or through-pressure.

It has already been mentioned that the magnetic field in question generated by the coils 14, which is not explicitly illustrated, is a traveling field which in particular follows the direction of flow 8 and subsequently the discharge direction 36 of the magnetic particles. In this connection a careful design of the magnetizing coils 14 and the choice of sufficiently high electrical currents in the coils in the transition zone between the first region 10 and the second region 12 or the second region 12 into the third region 26 are necessary in order to ensure a reliable discharge of the concentrate.

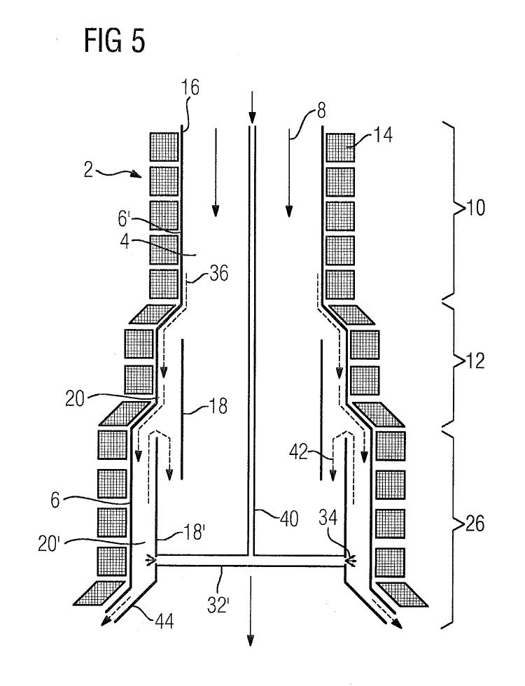

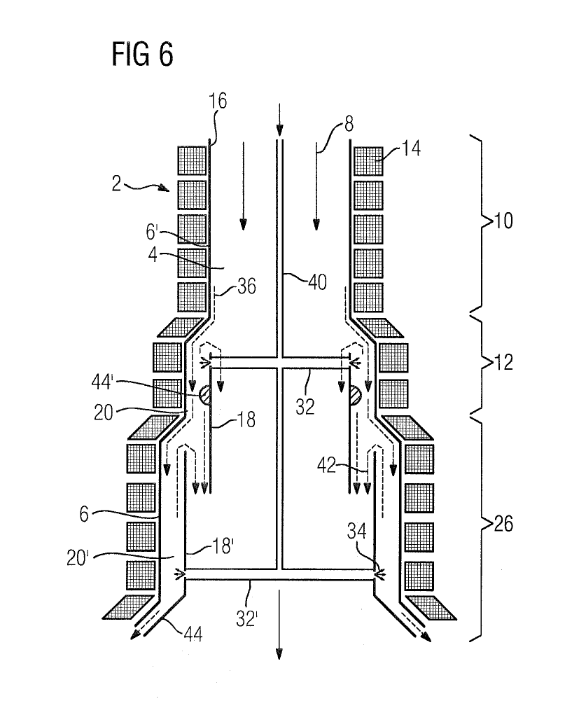

A two-stage tubular reactor 6′ is illustrated in each of FIGS. 5 and 6, wherein a flushing device 32′ is provided in the third region 26 in FIG. 5, and a flushing device 32 and 32′ respectively is arranged in each case both in the second region 12 and also in the third region 26 in FIG. 6. The flushing water jet of the flushing device 32, 32′ causes turbulence in the mixture including magnetic and accompanying non-magnetic material transported downwards on the inside reactor wall 16, in other words the tailings. While the magnetic material is attracted to the reactor wall again below the flushing liquid outlet 34 in the direction of flow 8, the tailings are transported by the flushing liquid 4 along the arrow 42 back into the tailings discharge pipe 18′ or 18.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-7. (canceled)

8. A device for separating magnetic particles from a suspension, comprising:
a tubular reactor through which the suspension can flow, the tubular reactor having a first region with respect to a direction of flow and a second region with respect to the direction of flow, the second region having a larger cross-sectional area than the first region;
a device to generate a magnetic field along an inside wall of the tubular reactor, such that the magnetic field extends at least partially into the second region;
a second region tailings discharge pipe provided in the second region of the tubular reactor; and
a second region concentrate separation channel surrounding the second region tailings discharge pipe.

9. The device as claimed in claim 8, wherein the second region tailings discharge pipe has a cross-sectional area at least as large as the cross-sectional area of the first region of the tubular reactor.

10. The device as claimed in claim 8, wherein
tubular reactor has a third region after the first and second regions with respect the direction of flow,
a third region tailings discharge pipe is provided in the third region of the tubular reactor,
a third region concentrate separation channel surrounds the third region tailings discharge pipe, and
the third region having larger a cross-sectional area than the second region.

11. The device as claimed in claim 10, wherein the third region tailings discharge pipe has a cross-sectional area at least as large as the cross-sectional area of the second region of the tubular reactor.

12. The device as claimed in claim 10, further comprising a flushing device which flushes a flushing liquid into the third region concentrate separation channel.

13. The device as claimed in claim 12, wherein
the flushing device flushes the flushing liquid into the third region concentrate separation channel at an entry point, and
the third region concentrate separation channel is narrowed after the entry point with respect to the direction of flow.

14. The device as claimed in claim 10, wherein a flushing device is provided each of the second region and the third region, to flush a flushing liquid into the second region concentrate separation channel and the third region concentrate separation channel, respectively.

15. The device as claimed in claim 8, further comprising a flushing device which flushes a flushing liquid into the second region concentrate separation channel.

16. The device as claimed in claim 15, wherein
the flushing device flushes the flushing liquid into the second region concentrate separation channel at an entry point, and
the second region concentrate separation channel is narrowed after the entry point with respect to the direction of flow.
